(19) United States
(12) Patent Application Publication
(10) Pub. No.: US 2012/0084946 A1
(43) Pub. Date: Apr. 12, 2012

(54) WINDOW SCREEN REPLACEMENT LIFT TAB

(76) Inventor: Stephen Louis Gonzales, Austin, TX (US)

(21) Appl. No.: 12/899,047

(22) Filed: Oct. 6, 2010

(51) Int. Cl. B25G 1/10

(52) U.S. Cl. 16/422

(57) ABSTRACT

A sash lift tab having a base which is adapted to be temporarily fastened to the bottom rail of a window screen sash and a handle portion extending inward from the base to easily access for lifting or removing the screen without the need for hand tools once the original tabs or lifts have been broken or become unusable.

Surfaces on the handle portion and the base prevent the handle portion from turning beyond the active position and also from turning back toward the inactive position so that the handle portion is held rigidly in the active position for service use.

### FIELD OF THE INVENTION

The present invention relates to a screen or window sash lift tab which is temporarily secured to the bottom rail of a sash and is gripped by hand to slide the sash up, down or out of a window frame. Basically, sash lifts or tabs include a base which is the part fastened to the bottom rail and a handle portion which projects from the base outwardly from the rail. Conventionally, sash lifts are cast or molded as a single unitary piece.

### BACKGROUND OF THE INVENTION

Many windows in family dwellings have the capability to be manually opened by sliding the movable part of the window frame over the stationary part of the window frame exposing an opening to the outside environment. Typically, this opening is covered by a window sash or screen that serves to keep bugs and other flying insects from entering the dwelling through the opening while simultaneously allowing the circulation of outside air in and out of the dwelling. On occasion this window screen may be removed by a person for purposes of passing objects through the window opening or cleaning of the window and frame itself.

Removal of the window screen is accomplished by gripping two plastic lift tabs bound into the frame by the original window screen manufacturer. Over time and through exposure to hot and cold weather and repeated use, these original tabs can become brittle and break off. This leaves users with no way to lift out the window screen. Alternate methods of prying out the window screen may require the use of an implement such as a screwdriver or a similar tool that can scratch, warp or cause permanent damage to the screen which prohibits the replacement of the window screen back into the window frame. Having a simple way to replace the functionality of these broken or missing tabs may provide users with a renewed ability to lift out their window screens whenever desired.

### SUMMARY OF THE INVENTION

The general object of the present invention is to provide a removable novel screen sash tab or lift in which the handle portion is movable relative to the base and originally in an inactive position generally parallel to the plane of the screen or frame sash for ease of use on most window screens.

The object of the present invention is to provide a Window Screen Replacement Lift Tab apparatus that can allow users to easily remove a window's screen as needed. This product may be a one-piece, flat, metallic clip in a modified J-shape with a rubber or plastic coating on the entire body of apparatus to prevent scratching of window screen during installation and provide a tactile and soft surface to allow easy and comfortable lifting. This product clips onto the window screen frame at the location where the original manufacturer lift tab previously existed to function as a replacement for broken or damaged lift tabs. Once clipped onto the window screen frame, it serves as a new lifting mechanism for removal of the window screen from the frame. This item may be produced from a flexible, yet durable material that can repeatedly bend without breaking. It may be produced as an accessory for existing windows or as a feature on future models. The exact dimensions, materials used for construction and method of operation of Window Screen Replacement Lift Tab may vary upon manufacturing.

Window Screen Replacement Lift Tab is a device that clips onto a window screen frame to enable users to easily lift the screen when traditional tabs can no longer be used. This unique product virtually eliminates individuals having to employ standard built-in tabs that can easily break off after repeated use. It can also be a replacement for previously broken or missing built-in tabs. This innovative item is ideal for use by anyone looking for a simple, effective and reliable way to raise and lower their screen by utilizing a small and convenient tab that may last longer than standard, built-in tabs.

### BRIEF DESCRIPTION OF THE DRAWINGS

The present embodiment should be more fully understood when the written description is considered in conjunction with the drawings contained herein, wherein:

FIG. 1 is a perspective view of the vertical sliding metal window frame casement showing movable pane partially open with installed window screen.

FIG. 2 shows a partial perspective view of the window screen frame (7), window screen mesh material (9), and window screen replacement lift tab (6) fastened onto the rail of the window screen frame.

FIG. 3 shows an enlarged perspective view of the invention providing contour detail of clip base and finger grip area.

FIG. 4 is a vertical section along line 11-11 of FIG. 3 showing the apparatus coating (12).

### DETAILED DESCRIPTION OF THE DRAWINGS

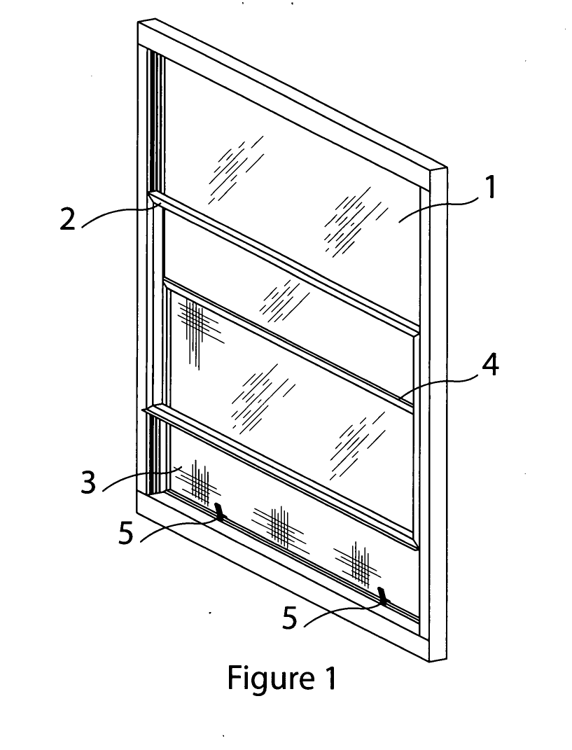

Referring to FIG. 1, a typical metal framed window is shown comprised of one stationary pane (1) and one movable pane (2) shown partially open. Typically, the movable pane at one side has a half screen (3) with its screen frame (4). There are two manufacturer provided lift tabs (5) bound into the window screen frame.

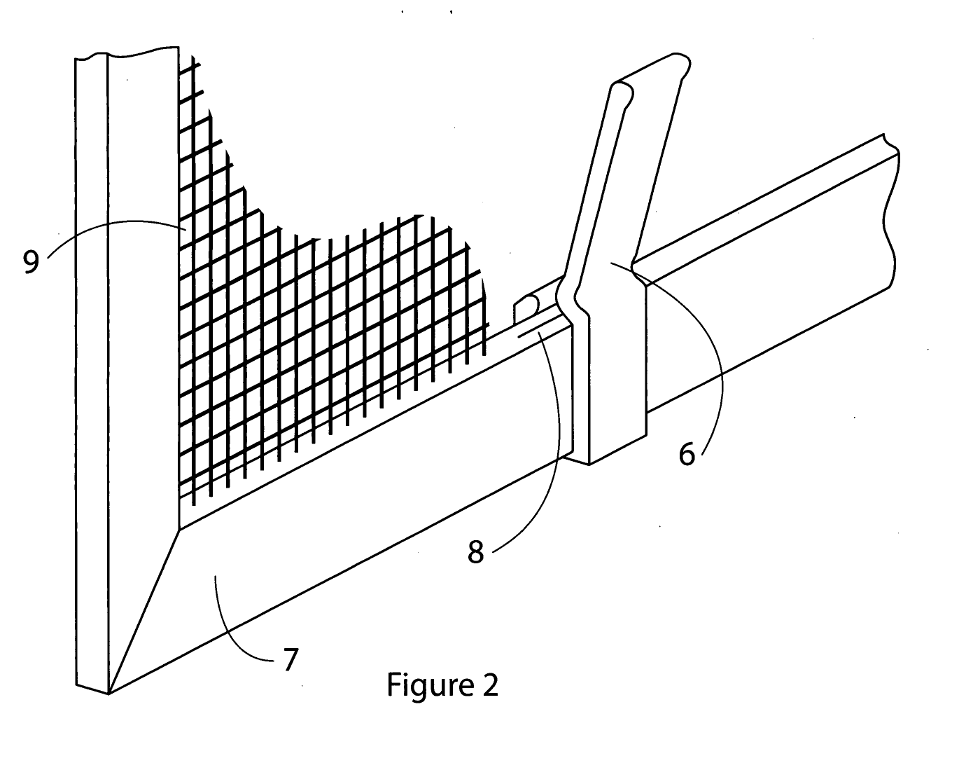

After repeated use these original lift tabs may break off or become unusable thereby requiring a replacement window screen lift tab as shown in FIG. 2. A novel lift tab (6) in accordance with this invention, is placed at a subject attach point on the window screen frame rail (7) at the location of unusable original manufacturer lift tab (8).

The window screen replacement lift tab invention has clip base portion and finger grip surface on the top part of the modified J-shape. The rail (7) of the window screen is enveloped by the clip base portion of the apparatus shown in FIG. 2 leaving the window screen material (9) free from contact.

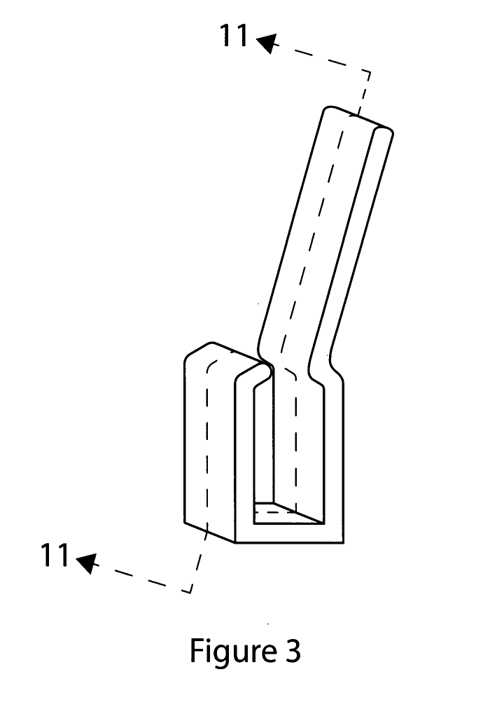

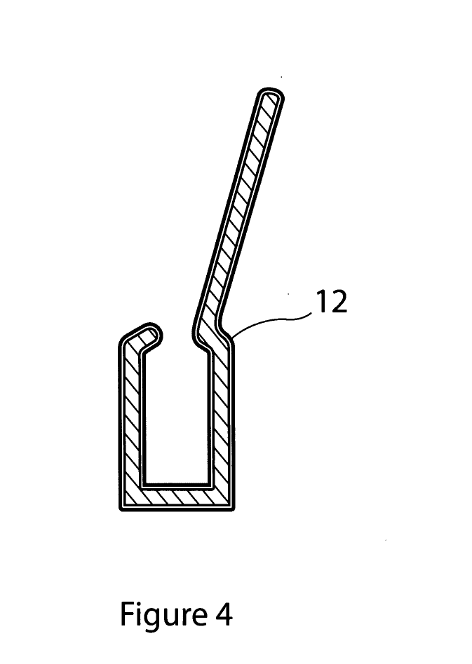

As shown in FIG. 3, a window screen lift tab apparatus may be a one-piece, flat, metallic clip of consistent thickness in a modified J-shape with a rubber or plastic coating. The unitary piece of metallic material should be durable and resilient enough to provide an operating range that allows a varied degree of angles that occur in material without breaking over many years of use. The coating (12) of the apparatus shown in FIG. 4, which could be of any color, should be tactile and soft to allow easy and comfortable lifting that also prevents scratching of screen frame during installation.

FIG. 2 clearly illustrates the principal feature of this invention. To use the window screen lift tab invention locate the subject attach point on the rail of the window screen at the location of the missing original manufacturer lift tab. Typically there are two mount sites is on the window screen rail as shown in FIG. 1. Mount the apparatus (6) at subject site (8) by urging the clip base onto the rail (7) until subject rail is fully enveloped. Securely hold the finger grip surface on the top part of J-shape such that angular tilt provides leverage at the mount site to lift out the window screen. The lift tab (6) assists the user in sliding the window screen up, down or out of the window frame. The lift tab (6) provides a new and comfortable grasping area for purpose of repositioning or removing the window screen that replaces functionality of the original lift tab that broke off or become unusable.

1. A window screen replacement lift tab apparatus comprising:
(a) A resilient piece of flexible material in a modified J-shape for use by fingers of a human hand providing an operating range that allows varied degrees of angle while lifting;
(b) A base which envelopes the bottom rail of the window screen frame to provide a non penetrating fit;
(c) A handle part being the top part of J-shape is the finger grip which extends upwardly and outwardly at an angle of about 10° to 35° away from plane of window screen mesh to provide sufficient clearance for grip by fingers of human hand.

2. A window screen replacement lift tab of claim 1 wherein the apparatus is of sufficient size for gripping by fingers of a human hand.

3. A window screen replacement lift tab of claim 1 wherein the apparatus provides a lifting capability for the window screen when original lift tabs are missing or broken.

4. A window screen replacement lift tab of claim 1 wherein the apparatus is installed at location of original lift tabs on bottom rail of window screen.

5. A window screen replacement lift tab of claim 1 wherein the apparatus is comprised of a resilient and flexible one piece metallic material that handles repeated use without breaking.

6. A window screen replacement lift tab of claim 1 wherein the one piece of metallic material is coated with a rubber or plastic material to provide a tactile surface for gripping.

7. A window screen replacement lift tab of claim 1 wherein the rubber or plastic coating may be colored to promote visibility.

8. A window screen replacement lift tab of claim 1 wherein the rubber or plastic coating extends around the entire exterior of the apparatus.

9. An apparatus for the manual urging of a window screen from the window frame housing; said window screen being movable in an outward arc relative to the plane of a window frame opening, said apparatus comprising;
(a) a unitary piece of flat metallic material formed into a modified J-shape with a base that envelopes the window screen rail and handle part that extends upwardly from the window screen rail and outwardly with slight angle relative to the plane of the window screen mesh; and
(b) the base is secured onto the rail of window screen frame at position of missing or broken original manufacturer lift tabs; and
(c) said base envelopes the window screen rail to provide a non-penetrating fit; and
(d) said unitary piece is made of resilient and flexible material capable of repeated flexing without breaking; and
(e) said handle extends upwardly and outwardly with sufficient angle away from plane of window screen mesh to provide clearance for grasping by human fingers.

10. The apparatus of claim 9 wherein said may be coated with a rubber or plastic material.

11. The apparatus of claim 9 wherein said the rubber or plastic coating may extend around the entire exterior of the apparatus.

12. The apparatus of claim 9 wherein said the rubber or plastic coating may be colored.
